(19) United States
(12) Patent Application Publication
(10) Pub. No.: US 2023/0376178 A1
(43) Pub. Date: Nov. 23, 2023

(54) Information exchange system and method for enhanced collaboration

(71) Applicant: Hubilo Technologies, Inc., San Francisco, CA (US)

(72) Inventor: Shaileshchandra Hegde, Bangalore (IN)

(73) Assignee: Hubilo Technologies, Inc., San Francisco, CA (US)

(21) Appl. No.: 17/944,246

(22) Filed: Sep. 14, 2022

(30) Foreign Application Priority Data
May 17, 2022 (IN) 202241028274

(51) Int. Cl. G06F 3/0484; H04L 65/401; G06F 3/14

(52) U.S. Cl. CPC G06F 3/0484; H04L 65/4015; G06F 3/1454

(57) ABSTRACT

According to this disclosure, an information exchange system is provided where once source content that a presenter chooses to display is received by all recipients, each recipient can use an input device (e.g., his or her mouse or keyboard) to hover or click on specific parts of the shared screen to interact and absorb information in ways that help them better understand what is being presented. The information exchange system comprises several components: an authoring (e.g., document creation) subsystem that allows the content creator to create and encode presentation-like content for certain data types to be sent along with the source video, a data channel connecting the source and destination endpoints and that transmits the encoded document content, and an application at the destination that decodes the content from the data channel and creates an overlay on the destination video that allows the recipient to interact with the decoded content and transform it into other formats as programmed by the content creator.

### BACKGROUND

### Technical Field

This disclosure relates generally to technologies, products and services for online collaboration.

### Background of the Related Art

Web conferencing refers to various types of online conferencing and collaborative services including webinars (web seminars), webcasts, and web meetings. In general, web conferencing is made possible by Internet technologies, particularly on TCP/IP connections. Services allow for real-time point-to-point communications, as well as multicast communications, typically from one sender to many receivers. It offers data streams of text-based messages, voice and video chat to be shared simultaneously, across geographically dispersed locations. Applications for web conferencing are quite varied and include meetings, training events, lectures, or presentations from a web-connected computer to other web-connected computers.

Screen sharing during a video conference allows a participating user to share his or her desktop, a window, an application or an audio/video. Some video conferencing products (e.g., Zoom) allow a user to send computer audio to the remote attendees when sharing a video or audio clip. For example, to share computer audio for videos during screen sharing, a video conference participant may be prompted to elect an option to “share computer sound.” In particular, and once the video conference meeting is opened and the user logged in as the speaker, he or she then selects a “share screen” icon or the like. In response, a pop-up window is displayed on the user's local display from which the user selects an input source, e.g., his or her desktop, or some application (e.g., a web browser open to a particular YouTube® video that the user wants to share). Once the selection is made, the user then clicks a checkbox for “share computer sound” or the like. As a result, and when the user is in a screen share mode, all computer sounds (e.g., the audio from the selected video) are then played to the other participants.

Other known systems enable a presenter to share a document with other participants, who then interact with the shared document. In a representative approach, e.g., as described in U.S. Pat. No. 7,099,798, a system includes a collaboration presentation module that allows a team member to select data via an integrated shared data module and display it to all the other members who are currently logged onto a worksite. Each such member has the ability, dependent on permission from the presenting team member, to interact with the displayed data. This interaction can include highlighting portions of the displayed data, using a pointer to call attention to a portion of the data, or modifying the data as desired. In this way, team members can collaborate on the preparation of a document or presentation, or one team member can present his or her work to the other members.

While the above-described solutions are representative of the prior art and provide useful features and functions, there remains a need to provide enhancements to these approaches that enable full and interactive collaboration among the participants.

The technique herein addresses this need.

### BRIEF SUMMARY

According to this disclosure, an information exchange system is provided where once source content that a presenter chooses to display is received by all recipients, each recipient can use an input device (e.g., his or her mouse or keyboard) to hover or click on specific parts of the shared screen to interact and absorb information in ways that help them better understand what is being presented. For instance, a line graph that is presented on the shared screen may be touched and transformed by any recipient, preferably within the context of his or her own display view, e.g., to modify into a pie chart for better understanding and visualization. Preferably, such modifications affect only the view of the recipient making the changes and are not synchronized back to the presenter or the other participants. Similarly, a piece of content that is abbreviated by the presenter may be hovered upon or clicked by any recipient to display the full form. Generalizing, this collaboration function is enabled by having the presenter (or an entity operating on his or her behalf) pre-create such content, e.g., with markers or hidden information, that accompany transmission of the presenter's screen. Upon invocation by a recipient (locally on the recipient's side), the system extracts this information to display and/or transform it locally.

The information exchange system comprises several components: an authoring (e.g., document creation) subsystem that allows the content creator to create and encode presentation-like content for certain data types like graphs and text, to be sent along with the source video, a data channel connecting the source and destination endpoints and that transmits the encoded document content, and an application at the destination that decodes the content from the data channel and creates an overlay on the destination video that allows the recipient to interact with the decoded content and transform it into other formats as programmed by the content creator.

The foregoing has outlined some of the more pertinent features of the subject disclosure. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 depicts a representative live video webcast and the supporting service provider infrastructure in which the collaboration techniques of this disclosure may be carried out;

FIG. 2 depicts the webcast and infrastructure in FIG. 1 augmented to include an information exchange system according to this disclosure; and

FIG. 3 depicts an example of how an interactive content element is rendered on a recipient's display according to the techniques herein.

### DETAILED DESCRIPTION OF AN ILLUSTRATIVE EMBODIMENT

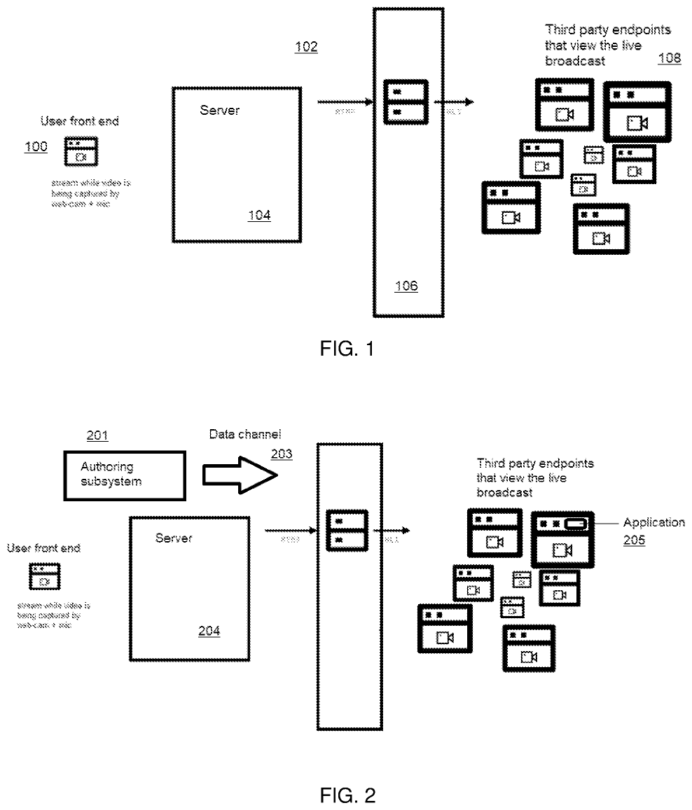

FIG. 1 depicts a simplified representation of a live video webcast involving a presenter and a set of one or more recipients. In this example, each person involved in the collaboration has a computing machine (e.g., a desktop, a laptop, a tablet, a smart phone, or the like) having a processor, memory, storage, I/O, and display. As depicted, the presenter has a computing machine 100 comprising input devices such as a webcam and microphone. One or more service providers 102 provides infrastructure supporting the collaboration. For browser-based collaboration, the presenter opens his or her browser to a session and begins speaking (broadcasting). The webcam and microphone capture the presenter's video and audio, and these streams are transmitted, typically via a WebRTC connection, to a server 104. The server joins the broadcast and captures video frames and audio (e.g., using an architecture based on Jitsi, an open source video conferencing framework). These frames and audio are then encoded and output from the server over RTMP to a delivery system 106. Delivery system 106 transcodes the output(s) received from the server 104 into a suitable delivery format (e.g., HLS), and publishes the broadcast, e.g., as an RTMP stream available at a URL. Delivery may involve a content delivery network (CDN), which is not shown. Participants 108 open their respective browser(s) to the stream URL and watch the presentation on their local computing machines.

According to this disclosure, the above-identified webcasting infrastructure and techniques are enhanced as now depicted in FIG. 2. As shown, an information exchange system 200 comprising a set of additional components that augment that infrastructure from FIG. 1. In particular, the information exchange system comprises an authoring subsystem 201, a data channel 203, and an application 205. Generalizing, the authoring subsystem 201 allows a content creator (e.g., the presenter) to create and encode presentation-like content for certain data types to be sent along with the presenter's source video and audio. The data channel 203 connects the presenter and recipient(s) (i.e., source and destination endpoints) and transmits the encoded presentation content for rendering on the recipient display(s). The application 205, which typically executes as a plug-in or script in the recipient's browser, decodes the content from the data channel 203 and creates an overlay on the local display that allows the recipient to interact with the decoded content and transform it into other formats as programmed by the content creator.

In a representative embodiment, authoring subsystem 201 is web-based and is accessible from a secure web page. In this example, the subsystem 201 is associated with the server 204, although this is not a requirement. In the usual case the server 204 comprises one or more machines operating in a cluster of such machines to ensure scalability, reliability and availability. The user (typically the presenter or a person acting on the presenter's behalf) accesses the subsystem 201 via a web browser over a secure connection. In an alternative embodiment, the subsystem is an application that executes on-premises or in a stand-alone manner. The subsystem supports one or more web pages with interactivity via one or more display elements, such as fill-in forms, drop boxes, selection buttons, and the like. By entering data into the display elements, the presenter creates presentation content that is to be associated with a video broadcast. The nature of the presentation content may vary depending on the subject matter of the broadcast, the presenter, one or more preferences, and other considerations. The subsystem may provide one or more document templates, or display type element templates, to facilitate the content preparation. In one non-limiting example, the presentation content comprises a document with one or more pieces of content. A piece of content has an associated data type, such as text, a line, a chart, a graph, an image, and the like. In a typical use case, the document itself is adapted to be screen-shared with the recipient(s) during the video presentation.

During an authoring session, and using the interactive display elements, the presenter then creates the presentation content comprising one or more interactive elements. For example, one such interactive element may be a line graph. During content creation, the presenter identifies one or more ways in which the line graph may be touched and transformed by a recipient who obtains the document, e.g., via the screen share. The nature of the touch/transform depends on the data type, but may include any type of interactivity (e.g., scaling, rotating, translating, adding color or shading, and so forth) that the content author desires to add to the element. In another example, the interactive element is a piece of text, such as an abbreviation, and the interactivity causes display of the full text associated with the abbreviation. In still another example, the content is an image, and the interactivity enables a zoom operation with respect to some portion of the image. The above examples are merely illustrative, and they are not intended to be taken by way of limitation. As noted above, the particular nature of the interactivity will vary, and the display elements provided by the authoring subsystem facilitate rapid content creation. Based on the inputs received, the authoring subsystem creates a data set comprising a set of one or more content elements and, for each such content element, its associated interactivity. As used herein, interactivity refers to the nature of a recipient-side interaction permitted with respect to the content element, and an associated response to that interaction. The interaction may vary from view-only, view-and-edit, view-edit-save, and the like. Typically, the associated response is implemented by one or more of: markers, hidden control information, scripts, code, or other control(s) that affect display modifications. Using an encoding module of the authoring subystem, the data set is then encoded into a set of control instructions that are deliverable in association with the underlying document that the presenter intends to screen share during the session.

Assume now that the webcast has begun and the presenter has initiated the video broadcast and the screen share. Upon selection of the document for screen share, the set of control instructions created by the authoring subsystem are then transmitted over the data channel to each of the recipients. As depicted in FIG. 2, typically the data channel connects the source (the presenter's computing machine) to the recipient machines indirectly, i.e. via the server and delivery infrastructure. In other words, the interactivity information in the data channel is passed through to the recipients in association with the screen share so that the control information encoded therein is then available for use on the recipient display(s) as the recipients watch the video broadcast and concurrently view the document screen share. At the recipient side, the application 205 executes, typically in association with the recipient's browser (as a plug-in, as a script, or as native code. The application 205 performs several functions: it creates a transparent overlay on top of the document, and it decodes the hidden information, markers, or the like (that were created by the encoding module on the authoring side) to facilitate rendering of the interactivity associated with the content element. Continuing with the examples described above, if the content element was a line graph, the application 205 decodes the instructions such that when the recipient hovers his or his mouse (or makes a keyboard selection) with respect to the content element, the element is transformed (and rendered on the transparent overlay) in whatever manner the content author provisioned (e.g., transformation into a pie chart for better understanding and visualization). If the content element is a text abbreviation, when the recipient hovers his or her mouse cursor on the text, the application decodes and renders (on the overlay) the full text. Preferably, when the recipient moves his or her mouse away from the interactive content element, the local display (of the content element) returns to its original form. In an alternative embodiment, once the interactivity is triggered for a content element, the modified (transformed) element remains on the overly persistently. Generalizing, the application decodes the control information received over the data channel, creates the transparent overlay, and provides the decoded content on the overlay to enable the recipient to view and even interact with the content as programmed by the content creator.

Preferably, each of the recipients receives the same control information. Local display of the interactive content typically depends on whether the recipient takes some action (e.g., positioning a mouse cursor, entering a keyboard command, etc.) with respect to a piece of content that is enabled for interactivity in the manner described. In certain cases, the local display of the interactive content may occur automatically (by default) without recipient action. In addition, the control information itself may render one or more visual cues to indicate to the recipient that a piece of content in the document being screen-shared is interactive content. Thus, for example, a visual cue may be a change in color or formatting, a separate display menu that prompts the recipient to take action, or even audible prompts.

The transparent overlay may be created by the application using local (operating system-based) resources, or it may be created by the application directly.

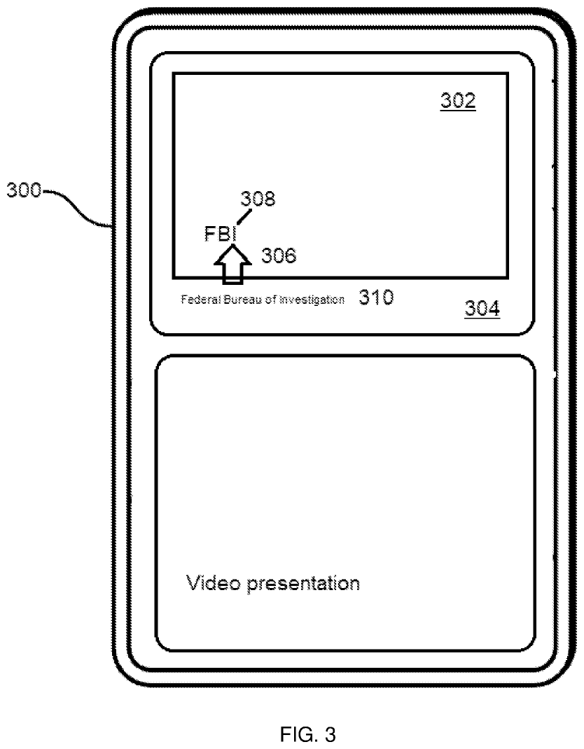

FIG. 3 depicts an example of a recipient's display 300 showing the screen-shared document 302, as well as the transparent overlay 304. As depicted, the recipient has placed the mouse cursor 306 over text abbreviation 308 that is an interactive content element, i.e., the element has been authored to include interactivity. When the mouse cursor 306 hovers over the text abbreviation 308, the application docodes the control instructions and renders the full text 310 on the overlay. Each individual interactive control element is processed in a similar manner, with the nature of the interactivity being as programmed by the content creator, all as previously described.

Preferably, the interactivity affects only the view of the recipient and is not synchronized back to the presenter or the other participants.

The approach herein provides significant advantages. Using the above-described techniques, much more robust collaboration is provided, as individual recipients are enabled the ability to interact directly with content elements that have been programmed by the content creator. By interacting with the content elements, the recipient(s) can obtain more fine-grained information or otherwise obtain useful data that might not otherwise be available by simple viewing of the screen-shared document in which the interactive content elements reside.

As noted, the interactive control elements typically are embedded within a document intended for screen sharing. The nature of the document may vary and may include, without limitation, a text document, a slide of a slide presentation, a visual source (separate from the presenter's video broadcast), or the like.

The information exchange system as described above may be provided by a service provider, or in association with a separate webcasting service (e.g., Zoom®). While the underlying stream delivery (video encoding and decoding using WebRTC-based rebroadcast) typically conforms to the WebRTC standard, this is not a requirement. Video over WebSockets may be used as an alternative. Further, if either the presenter or recipient is located behind a firewall or NAT device, one or more STUN- or TURN-based servers may be used to facilitate the establishment and maintenance of the connections.

Generalizing, one or more functions of the authoring system may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Content delivery may be carried using a commercial CDN service.

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

### Additional Enabling Technologies

A typically computing device associated with a presenter or recipient is a mobile device or tablet computer. Such a device typically comprises a CPU, computer memory, such as RAM, and a drive. The device software includes an operating system (e.g., Apple iOS, Google® Android™, or the like), and generic support applications and utilities. The device may also include a graphics processing unit (GPU). It also includes a touch-sensing device or interface configured to receive input from a user's touch and to send this information to the processor. The touch-sensing device typically is a touch screen. The touch-sensing device or interface recognizes touches, as well as the position, motion and magnitude of touches on a touch sensitive surface (gestures). The device typically also comprises a high-resolution camera for capturing images, an accelerometer, a gyroscope, and the like.

In one embodiment, a cloud service provider provides the delivery service, the information exchange system, and any necessary identity management service or support.

In another embodiment, the cloud service provider provides the delivery service while other entities provide the information exchange system.

The cloud service is a technology platform that may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the cloud service comprises a set of one or more computing-related entities (systems, machines, processes, programs, libraries, functions, or the like) that together facilitate or provide the functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The computing entity on which the browser and its associated browser plug-in run may be any network-accessible computing entity that is other than the mobile device that runs the authenticator app itself. Representative entities include laptops, desktops, workstations, Web-connected appliances, other mobile devices or machines associated with such other mobile devices, and the like.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

The described commercial products, systems and services are provided for illustrative purposes only and are not intended to limit the scope of this disclosure.

The techniques herein provide for improvements to technology or technical field, as well as improvements to various technologies, all as described.

Having described the subject matter, what is claimed is as follows:

1. A method for collaboration among a presenter, and a set of one or more recipients, each of the presenter and the one or more recipients having a computing machine including a display, comprising:
receiving authoring data associated with a content element of a document, the authoring data identifying the content element and an associated interactivity for the content element;
responsive to receipt of the authoring data, generating an interactive control element that comprises control information;
encoding the control information and associating the encoded control information with a presentation document;
responsive to initiation of a screen share of the presentation document, and in association with a broadcast initiated by the presenter, delivering the encoded control information to the set of one or more recipients, the encoded control information configured to be decoded and executed in association with an interaction with the content element during the broadcast and screen share.

2. The method as described in claim 1 wherein the encoded control information is delivered over a data channel distinct from a delivery channel over which the broadcast or the screen share are provided.

3. The method as described in claim 1 wherein the authoring data is received from the presenter.

4. The method as described in claim 3 wherein the encoded control information is configured by the presenter to define a given interactivity.

5. The method as described in claim 1 wherein executing the decoded control information adjusts a rendering of the content element.

6. The method as described in claim 5 wherein rendering of the content element is adjusted on a display associated with a given recipient.

7. The method as described in claim 6 wherein the interaction is a mouseover or receipt of a keyboard command.

8. The method as described in claim 1 wherein the presentation documents includes one or more additional interactive control elements.

9. A method for collaboration among a presenter, and a recipient of a set of recipients, each of the presenter and the recipients having a computing machine including a display, comprising:
at the computing machine of a recipient:
receiving a video rebroadcast of a presentation initiated by the presenter;
responsive to initiation of a screen share of a presentation document, receiving, via a data channel, encoded control information, the encoded control information associated with an interactive control element that has been configured for a content element in the presentation document;
rendering the presentation document including the content element; and
responsive to receipt of input data associated with the content element, decoding the encoded control information and adjusting a rendering of the content element.

10. The method as described in claim 9 further including:
rendering a transparent overlay;
generating a transform of the content element; and
displaying the transformed content element on the transparent overlay.

11. The method as described in claim 9 wherein the input data is a mouseover or keyboard command.

12. The method as described in claim 9 further including rendering a visual cue to identify the content element as being configured as the interactive control element.

13. The method as described in claim 9 wherein adjustment of the rendering of the content element ends upon cessation of receipt of the input data.

14. The method as described in claim 9 wherein the presentation document includes one or more additional interactive control elements.

15. The method as described in claim 9 wherein the presentation document is rendered in a web browser.

16. The method as described in claim 9 wherein the content element is one of: text, a graphic, and an image.

17. Software-as-a-service infrastructure for collaboration among a presenter, and a set of one or more recipients, each of the presenter and the one or more recipients having a computing machine including a display, comprising:
a set of hardware processors;
computer memory holding computer program code executed by the one or more hardware processors, the computer program code comprising:
an authoring subsystem that receives authoring data associated with a content element of a document, the authoring data identifying the content element and an associated interactivity for the content element, generates an interactive control element that comprises control information, encodes the control information, and associates the encoded control information with a presentation document; and
a video subsystem that facilitates rebroadcast to the one or more recipients a video presentation initiated by the presenter, the video subsystem comprising a data channel;
wherein, responsive to initiation of a screen share of the presentation document during the rebroadcast, the encoded control information is delivered over the data channel to the set of one or more recipients, the encoded control information configured to be decoded and executed in association with an interaction with the content element during the broadcast and screen share.

18. A computer program product in a non-transitory computer-readable medium, the computer program product comprising computer program code executable by a hardware processor, the computer program code configured to:
responsive to initiation of a screen share of a presentation document during a video broadcast, receive, via a data channel, encoded control information, the encoded control information associated with an interactive control element that has been configured for a content element in the presentation document;
render the presentation document including the content element; and
responsive to receipt of input data associated with the content element, decode the encoded control information and adjust a rendering of the content element.

19. The computer program product as described in claim 18 wherein the computer program code is further configured to:
initial rendering of a transparent overlay;
generating a transform of the content element; and
display the transformed content element on the transparent overlay.

20. The computer program product as described in claim 18 wherein the input data is a mouseover or keyboard command.
